(19) United States
(12) Patent Application Publication
(10) Pub. No.: US 2012/0093348 A1
(43) Pub. Date: Apr. 19, 2012

(54) Generation of 3D sound with adjustable source positioning

(75) Inventor: Yunhong Li, Santa Clara, CA (US)

(73) Assignee: NATIONAL SEMICONDUCTOR CORPORATION, Santa Clara, CA (US)

(21) Appl. No.: 12/925,121

(22) Filed: Oct. 14, 2010

(51) Int. Cl. H04R 5/02

(52) U.S. Cl. 381/300

(57) ABSTRACT

A system for generating 3D sound with adjustable source positioning includes a first stage and a second stage, which is coupled to the first stage and to a speaker array that includes a plurality of speakers. The first stage is configured to position a plurality of virtual sound sources through a positioner output. The second stage is configured to generate a 3D signal for the speaker array based on the positioner output. The speaker array is configured to generate a 3D sound stage including the virtual sound sources based on the 3D signal. The first stage may be further configured to reposition the virtual sound sources.

### CROSS-REFERENCE TO RELATED APPLICATION

This application is related to U.S. patent application Ser. No. 12/874,502 filed on Sep. 2, 2010, which is hereby incorporated by reference.

### TECHNICAL FIELD

This disclosure is generally directed to audio systems. More specifically, this disclosure is directed to generation of 3D sound with adjustable source positioning.

### BACKGROUND

Stereo speaker systems have been used in numerous audio applications. A stereo speaker system usually generates a sound stage that is restricted by the physical locations of the speakers. Thus, a listener would perceive sound events limited to within the span of the two speakers. Such a limitation greatly impairs the perceived sound stage in small-size stereo speaker systems, such as those found in portable devices. In the worst cases, the stereo sound almost diminishes into mono sound.

To overcome the size limitation of small stereo systems and widen the sound stage for general stereo systems, 3D sound generation techniques may be implemented. These techniques usually expand the stereo sound stage by achieving better crosstalk cancellation, as well as enhancing certain spatial cues. However, the 3D effects generated by a stereo speaker system using conventional 3D sound generation techniques are generally not satisfactory because the degrees of freedom in the design are limited by the number of speakers.

### BRIEF DESCRIPTION OF DRAWINGS

For a more complete understanding of this disclosure and its features, reference is now made to the following description, taken in conjunction with the accompanying drawings, in which:

FIG. 1A illustrates an audio system capable of generating 3D sound with adjustable source positioning in accordance with one embodiment of this disclosure;

FIG. 1B illustrates the audio system of FIG. 1A in accordance with another embodiment of this disclosure;

FIG. 2A illustrates the source positioner of FIG. 1A or 1B for the case of mono or stereo inputs in accordance with one embodiment of this disclosure;

FIG. 2B illustrates details of the source positioner of FIG. 2A in accordance with one embodiment of this disclosure;

FIG. 3A illustrates the source positioner of FIG. 1A or 1B for the case of multi-channel inputs in accordance with one embodiment of this disclosure;

FIG. 3B illustrates details of the source positioner of FIG. 3A in accordance with one embodiment of this disclosure;

FIG. 4A illustrates the 3D sound generator of FIG. 1A or 1B in accordance with one embodiment of this disclosure;

FIG. 4B illustrates details of the 3D sound generator of FIG. 4A in accordance with one embodiment of this disclosure;

FIG. 5A illustrates the audio system of FIG. 1A or 1B with the source positioner of FIG. 2B and the 3D sound generator of FIG. 4B in accordance with one embodiment of this disclosure;

FIG. 5B illustrates the audio system of FIG. 1A or 1B with the source positioner of FIG. 3B and the 3D sound generator of FIG. 4B in accordance with one embodiment of this disclosure;

FIG. 6 illustrates one example of a 3D sound stage generated by the audio system of FIG. 1A or 1B in accordance with one embodiment of this disclosure;

FIG. 7 illustrates a method for generating 3D sound with adjustable source positioning in accordance with one embodiment of this disclosure; and

FIG. 8 illustrates one example of an audio amplifier application including the audio system of FIG. 1A or 1B in accordance with one embodiment of this disclosure.

### DETAILED DESCRIPTION

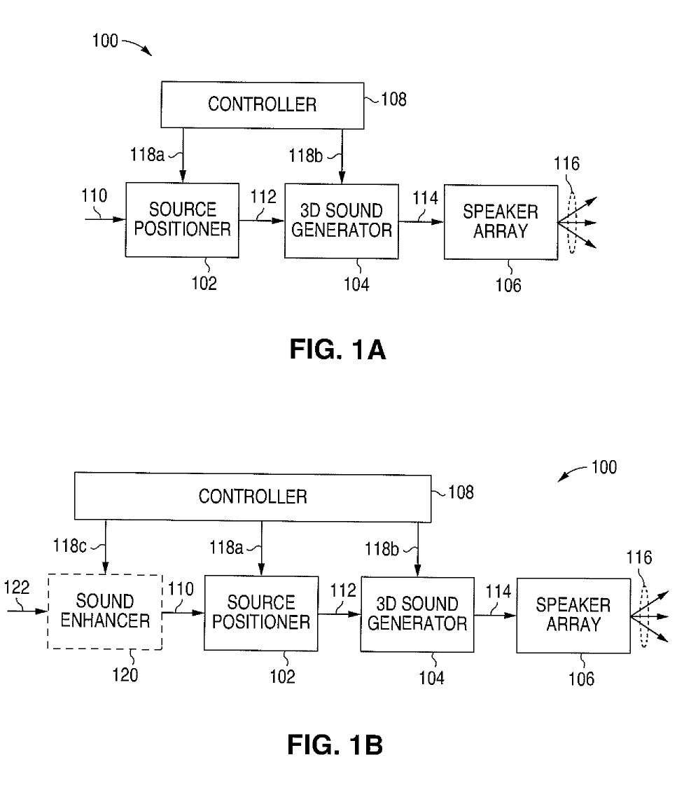

FIGS. 1 through 8, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1A illustrates an audio system 100 capable of generating 3D sound with adjustable source positioning in accordance with one embodiment of this disclosure. The audio system 100 comprises a source positioner 102, a 3D sound generator 104 and a speaker array 106. For some embodiments, the audio system 100 may also comprise a controller 108.

The source positioner 102 is capable of receiving an audio input 110 and generating a positioner output 112 based on the audio input 110, as described in more detail below. The 3D sound generator 104 is coupled to the source positioner 102 and is capable of receiving the positioner output 112 and generating a 3D signal 114 based on the positioner output 112, as described in more detail below. The speaker array 106, which is coupled to the 3D sound generator 104, comprises a plurality of speakers and is capable of receiving the 3D signal 114 and generating a customizable 3D sound stage 116 based on the 3D signal 114, as described in more detail below. Each speaker in the speaker array 106 may comprise any suitable structure for generating sound, such as a moving coil speaker, ceramic speaker, piezoelectric speaker, subwoofer, or any other type of speaker.

For the embodiments that include the controller 108, the controller 108 may be coupled to the source positioner 102 and/or the 3D sound generator 104 and is capable of generating control signals 118 for the audio system 100. For example, the controller 108 may be capable of generating a position control signal 118a for the source positioner 102, and the source positioner 102 may then be capable of generating the positioner output 112 based on both the audio input 110 and the position control signal 118a. Similarly, the controller 108 may be capable of generating a 3D control signal 118b for the 3D sound generator 104, and the 3D sound generator 104 may then be capable of generating the 3D signal 114 based on both the positioner output 112 and the 3D control signal 118b.

For some embodiments, the controller 108 may be capable of bypassing the source positioner 102 and/or the 3D sound generator 104. Thus, for example, the controller 108 may use the position control signal 118a to bypass the source positioner 102, thereby providing the audio input 110 directly to the 3D sound generator 104. The controller 108 may also use the 3D control signal 118b to bypass the 3D sound generator 104, thereby providing the positioner output 112 directly to the speaker array 106.

In general, the 3D sound generator 104 is capable of generating the 3D signal 114 such that a 3D sound stage 116 may be produced for a listener, allowing the listener to hear through virtual speakers a sound stage 116 that sounds as if it is being generated by sound sources at locations other than the speakers 106 themselves, i.e., at the locations of the virtual speakers.

The source positioner 102 is capable of adjusting the relative positions of those sound sources, making them sound as if they are closer together or farther apart based on the customization desired. For one example, the controller 108 may direct the source positioner 102 to adjust the positions of the sound sources through the position control signal 118a. For some embodiments, the controller 108 and/or the source positioner 102 may be controlled by a manufacturer or user of the audio system 100 in order to achieve the desired source positioning.

In this way, a two-stage system 100 is implemented that provides for the creation of virtual speakers through one stage, i.e., the 3D sound generator 104, and provides for an adjustable separation between the virtual speakers through another stage, i.e., the source positioner 102.

FIG. 1B illustrates the audio system 100 in accordance with another embodiment of this disclosure. For this embodiment, the audio system 100 comprises an optional third stage, which is an optional sound enhancer 120 that is coupled to the source positioner 102. For this embodiment, the sound enhancer 120 is capable of receiving an unenhanced input 122 and generating the audio input 110 for the source positioner 102 based on the unenhanced input 122. For some embodiments, the controller 108 may be coupled to the sound enhancer 120 and may be capable of generating an enhancement control signal 118c for the sound enhancer 120. For these embodiments, the sound enhancer 120 is capable of generating the audio input 110 based on both the unenhanced input 122 and the enhancement control signal 118c. The sound enhancer 120 may generate the audio input 110 by enhancing the unenhanced input 122 in any suitable manner. The sound enhancer 120 may enhance the unenhanced input 122 by inserting positive effects into the unenhanced input 122 and/or by reducing or eliminating negative aspects of the unenhanced input 122. For example, for a particular embodiment, the sound enhancer 120 may be capable of providing for the Hall effect and/or reverberance.

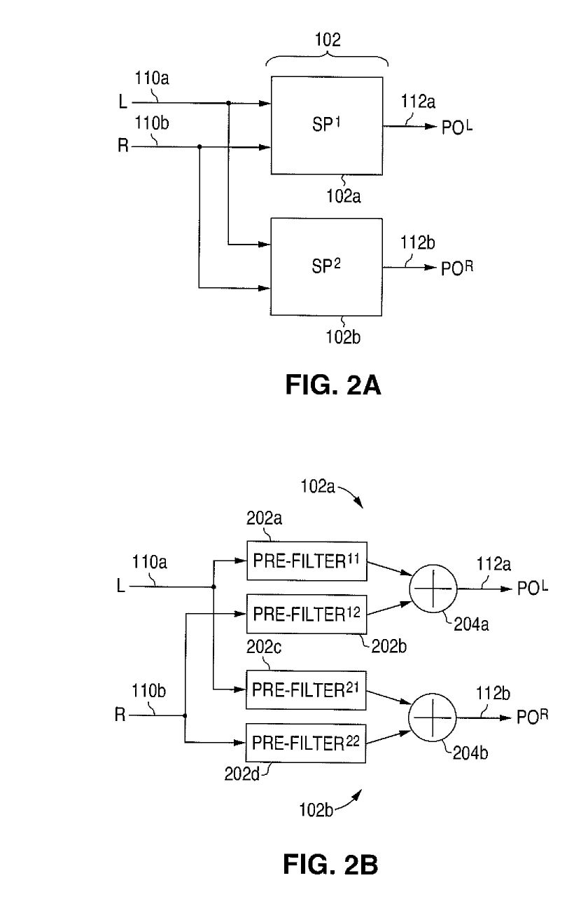

FIG. 2A illustrates the source positioner 102 for the case of mono or stereo inputs 110 in accordance with one embodiment of this disclosure. For this embodiment, the source positioner 102 comprises a first source positioner (SP₁) 102a and a second source positioner (SP₂) 102b. The audio input 110 for this embodiment comprises a left input 110a and a right input 110b, each of which is coupled to each of the source positioners 102a and 102b. The positioner output 112 for this embodiment comprises a left positioner output (PO_{L}) 112a and a right positioner output (PO_{R}) 112b. The SP₁ 102a is capable of generating the left positioner output 112a based on the left input 110a and the right input 110b. Similarly, the SP₂ 102b is capable of generating the right positioner output 112b based on the left input 110a and the right input 110b. For the case of a mono input 110, either of the audio inputs 110a or 110b may be muted or, alternatively, the mono input 110 may be fed to both the left input 110a and the right input 110b.

FIG. 2B illustrates details of the source positioner 102 of FIG. 2A in accordance with one embodiment of this disclosure. For this embodiment, the SP₁ 102a comprises a first pre-filter (pre-filter₁₁) 202a, a second pre-filter (pre-filter₁₂) 202b and a mixer 204a, and the SP₂ 102b comprises a first pre-filter (pre-filter₂₁) 202c, a second pre-filter (pre-filter₂₂) 202d and a mixer 204b.

For some embodiments, each pre-filter 202 may comprise a digital filter. The pre-filters 202 are each capable of adding spatial cues into the audio input 110 in order to control the span of the sound stage 116. For a particular embodiment, the pre-filters 202 may each be capable of applying a public or custom Head-Related Transfer Function (HRTF). HRTFs have been used in headphones to achieve sound source externalization and to create surround sound. In addition, HRTFs contain unique spatial cues that allow a listener to identify a sound source from a particular angle at a particular distance. Through HRTF filtering, spatial cues may be introduced to customize the 3D sound stage 116. For pre-filters 202 capable of applying HRTFs, the horizontal span of the sound stage 116 may be easily controlled by loading HRTFs in the pre-filters 202 that correspond to the desired angles. For some embodiments, the controller 108 may load an appropriate HRTF into each pre-filter 202 through the position control signal 118a.

The pre-filter₁₁ 202a is capable of receiving the left input 110a and filtering the left input 110a by applying an HRTF or other suitable function. Similarly, the pre-filter₁₂ 202b is capable of receiving the right input 110b and filtering the right input 110b by applying an HRTF or other suitable function. The mixer 204a is capable of mixing the filtered left and right inputs to generate the left positioner output 112a.

The pre-filter₂₁ 202c is capable of receiving the left input 110a and filtering the left input 110a by applying an HRTF or other suitable function. Similarly, the pre-filter₂₂ 202d is capable of receiving the right input 110b and filtering the right input 110b by applying an HRTF or other suitable function. The mixer 204b is capable of mixing the filtered left and right inputs to generate the right positioner output 112b.

Thus, if at least one of the pre-filters 202 is loaded with a different function for filtering the audio input 110, the source positioner 102 will generate a different positioner output 112, which may correspond to a different left positioner output 112a and/or a different right positioner output 112b, in order to reposition the sound stage 116.

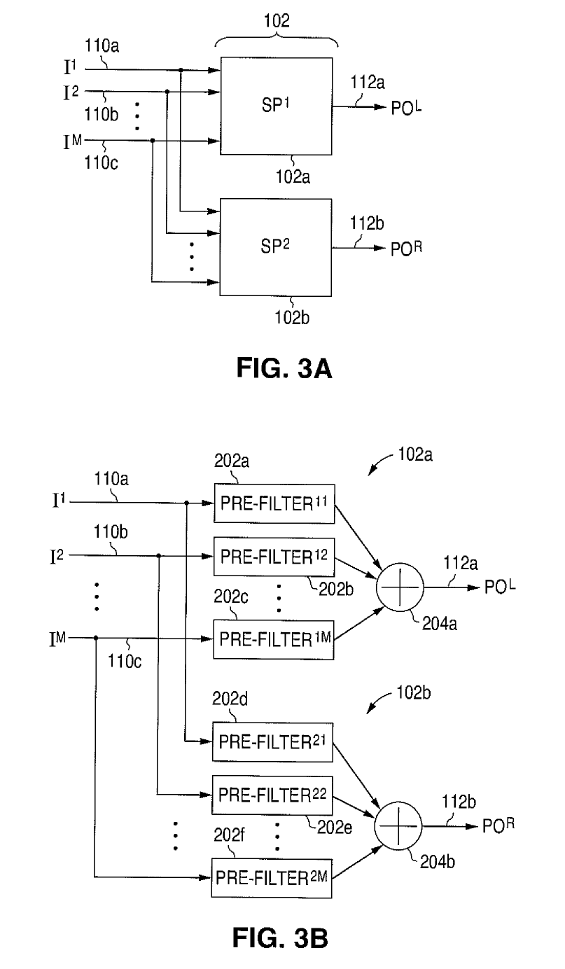

FIG. 3A illustrates the source positioner 102 for the case of multi-channel inputs 110 in accordance with one embodiment of this disclosure. For this embodiment, the source positioner 102 comprises a first source positioner (SP₁) 102a and a second source positioner (SP₂) 102b. The audio input 110 for this embodiment comprises more than two inputs, which are represented as inputs 1 through M (with M>2) in FIG. 3A. Each of the inputs 110a-c is coupled to each of the source positioners 102a and 102b. The positioner output 112 for this embodiment comprises a left positioner output (PO_{L}) 112a and a right positioner output (PO_{R}) 112b. The SP₁ 102a is capable of generating the left positioner output 112a based on inputs 1 through M 110a-c. Similarly, the SP₂ 102b is capable of generating the right positioner output 112b based on inputs 1 through M 110a-c.

FIG. 3B illustrates details of the source positioner 102 of FIG. 3A in accordance with one embodiment of this disclosure. For this embodiment, the SP₁ 102a comprises a plurality of pre-filters 202, with the number of pre-filters 202 equal to the number of inputs 110. The illustrated embodiment shows M inputs 110 and, thus, the SP₁ 102a comprises M pre-filters 202. The first, second and last pre-filters 202 are explicitly shown as pre-filter₁₁ 202a, pre-filter₁₂ 202b and pre-filter_{1M} 202c, respectively. The SP₁ 102a also comprises a mixer 204a. Similarly, the SP₂ 102b comprises M pre-filters 202. The first, second and last pre-filters 202 are explicitly shown as pre-filter₂₁ 202d, pre-filter₂₂ 202e and pre-filter_{2M} 202f, respectively. The SP₂ also comprises a mixer 204b.

It will be understood that the source positioners 102a and 102b may each comprise more pre-filters 202 than the number of inputs 110. However, if there are more pre-filters 202 than inputs 110, the additional pre-filters 202 will be unused. Thus, the number of pre-filters 202 provides a maximum number of inputs 110.

For some embodiments, each pre-filter 202 may comprise a digital filter. The pre-filters 202 are each capable of adding spatial cues into the audio input 110 in order to control the span of the sound stage 116. For a particular embodiment, the pre-filters 202 may each be capable of applying a conventional Head-Related Transfer Function (HRTF). HRTFs have been used in headphones to achieve sound source externalization and to create surround sound. In addition, HRTFs contain unique spatial cues that allow a listener to identify a sound source from a particular angle at a particular distance. Through HRTF filtering, spatial cues may be introduced to customize the 3D sound stage 116. For pre-filters 202 capable of applying HRTFs, the horizontal span of the sound stage 116 may be easily controlled by loading HRTFs in the pre-filters 202 that correspond to the desired angles. For some embodiments, the controller 108 may load an appropriate HRTF into each pre-filter 202 through the position control signal 118a.

The pre-filter₁₁ 202a and the pre-filter₂₁ 202d are each capable of receiving the first input (I₁) 110a and filtering the first input 110a by applying an HRTF or other suitable function loaded into that particular pre-filter 202a or 202d. Similarly, the pre-filter₁₂ 202b and the pre-filter₂₂ 202e are each capable of receiving the second input (I₂) 110b and filtering the second input 110b by applying an HRTF or other suitable function loaded into that particular pre-filter 202b or 202e. Each pre-filter 202 is capable of operating in the same way down through the last pre-filters 202c and 202f, which are each capable of receiving the final input (I_{M}) 110c and filtering the final input 110c by applying an HRTF or other suitable function loaded into that particular pre-filter 202c or 202f.

The mixer 204a is capable of mixing the filtered inputs generated by the SP₁ pre-filters 202a-c to generate the left positioner output 112a. Similarly, the mixer 204b is capable of mixing the filtered inputs generated by the SP₂ pre-filters 202d-f to generate the right positioner output 112b.

Thus, if at least one of the pre-filters 202 is loaded with a different function for filtering the audio input 110, the source positioner 102 will generate a different positioner output 112, which may correspond to a different left positioner output 112a and/or a different right positioner output 112b, in order to reposition the sound stage 116.

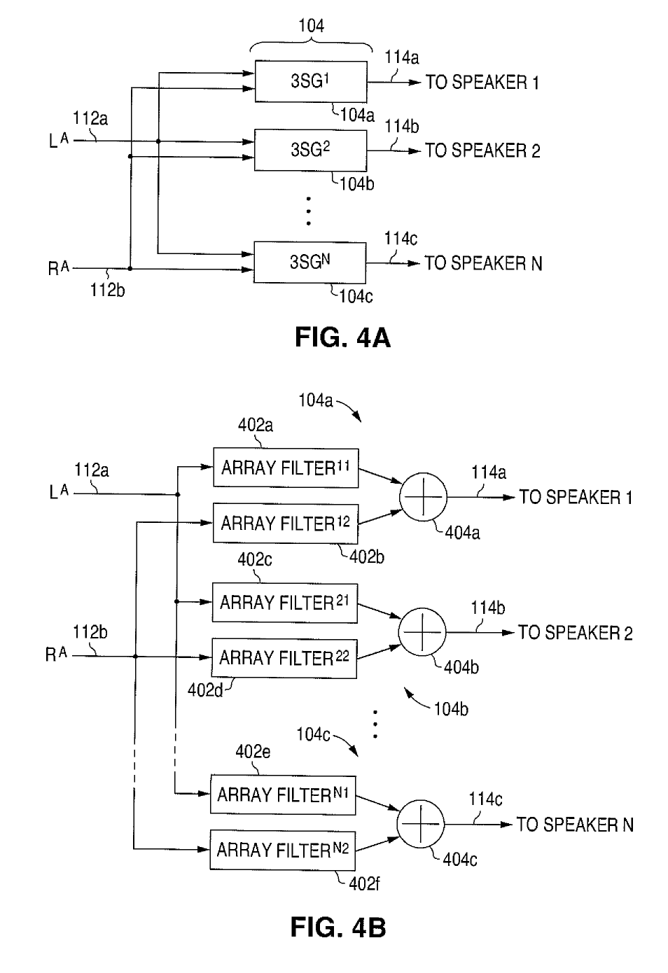

FIG. 4A illustrates the 3D sound generator 104 in accordance with one embodiment of this disclosure. For this embodiment, the 3D sound generator 104 comprises a plurality of 3D sound generators (3SGᵢ) 104a-c, with one 3SGᵢ for each speaker in the speaker array 106. The 3D signal 114 for this embodiment comprises a plurality of 3D signals 114a-c, one for each speaker in the speaker array 106. Each 3SGᵢ 104 is capable of receiving the left positioner output 112a and the right positioner output 112b from the source positioner 102 and generating a 3D signal 114 for a corresponding speaker based on the positioner outputs 112a and 112b.

FIG. 4B illustrates details of the 3D sound generator 104 of FIG. 4A in accordance with one embodiment of this disclosure. For this embodiment, the 3SG₁ 104a comprises a first array filter (array filter₁₁) 402a, a second array filter (array filter₁₂) 402b and a mixer 404a. Similarly, each remaining 3SGᵢ comprises a first array filter (array filter₁₁), a second array filter (array filter₁₂) and a mixer.

For some embodiments, each array filter 402 may comprise a digital filter capable of using filter coefficients to provide desired beamforming patterns in the sound stage 116 by filtering audio data. Each array filter 402 may be capable of implementing modified signal delays and amplitudes to support a desired beam pattern for conventional speakers or implementing modified cut-off frequencies and volumes for subwoofer applications. In general, each array filter 402 is capable of changing an audio signal's phase, amplitude and/or other characteristics to generate complex beam patterns in the sound stage 116. For some embodiments, each array filter 402 may comprise calibration and offset compensation circuits for speaker mismatch in phase and amplitude and circuit mismatch in phase and amplitude.

The array filter₁₁ 402a is capable of receiving the left positioner output 112a and filtering the left positioner output 112a by applying filter coefficients to the output 112a. Similarly, the array filter₁₂ 402b is capable of receiving the right positioner output 112b and filtering the right positioner output 112b by applying filter coefficients to the output 112b. The mixer 404a is capable of mixing the filtered, left and right positioner outputs to generate a 3D signal 114a for Speakerl.

Similarly, each first array filter₁₁ is capable of receiving the left positioner output 112a and filtering the left positioner output 112a, and each second array filter₁₂ is capable of receiving the right positioner output 112b and filtering the right positioner output 112b. The mixer 404 corresponding to each pair of array filters 402 is capable of mixing the filtered, left and right positioner outputs 112 to generate a 3D signal 114 for the corresponding speaker.

In this way, each speaker in the speaker array 106 may output a filtered copy of all input channels (whether mono, stereo or multi-channel), and the acoustic outputs from the speaker array 106 are mixed spatially to give the listener a perception of the sound stage 116. Thus, as described above, the 3D signal 114 for each speaker is generated based on the positioner outputs 112a and 112b, which are in turn generated based on both the left and right inputs 110 for stereo signals or on all the inputs 110 for a multi-channel signal.

The array filters 402 may be designed to generate a directional sound beam that goes toward the ears of the listener. For example, the array filters 402 associated with the left channel(s) are designed to direct the left channel audio to the left ear, while maintaining very limited leaks toward the right ear. Similarly, the array filters 402 associated with the right channel(s) are designed to direct the right channel audio to the right ear, while maintaining very limited leaks toward the left ear.

Thus, the set of array filters 402 of the 3D sound generator 104 is capable of delivering the audio to the desired ear and achieving good cross-talk cancellation between the left and right channels. Also, in this way, each speaker in the speaker array 106 may receive a 3D signal 114 from its own pair of local array filters 402.

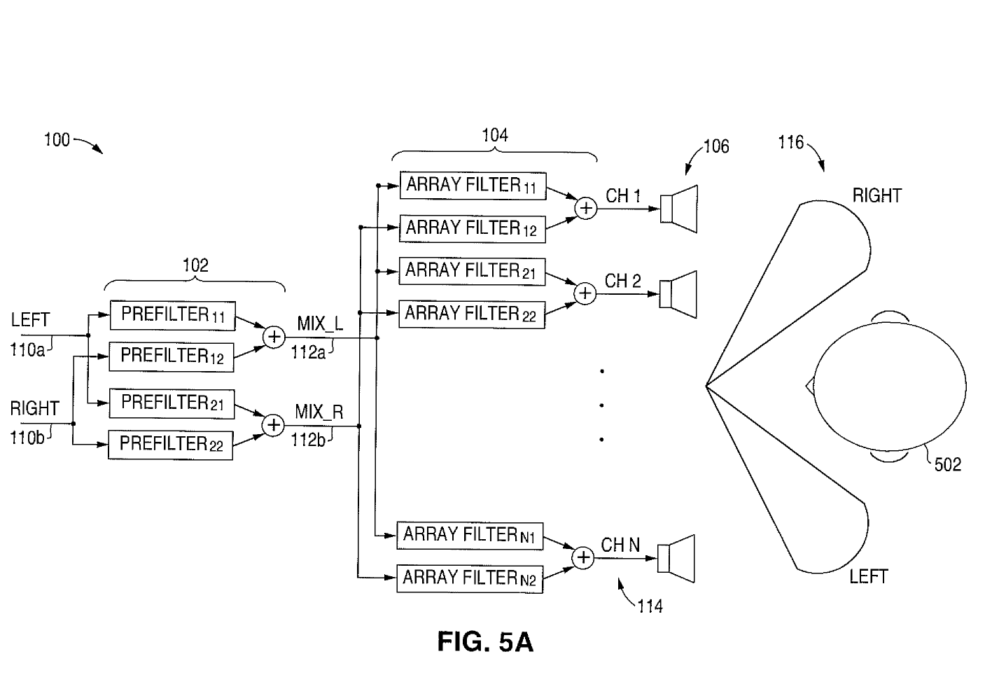

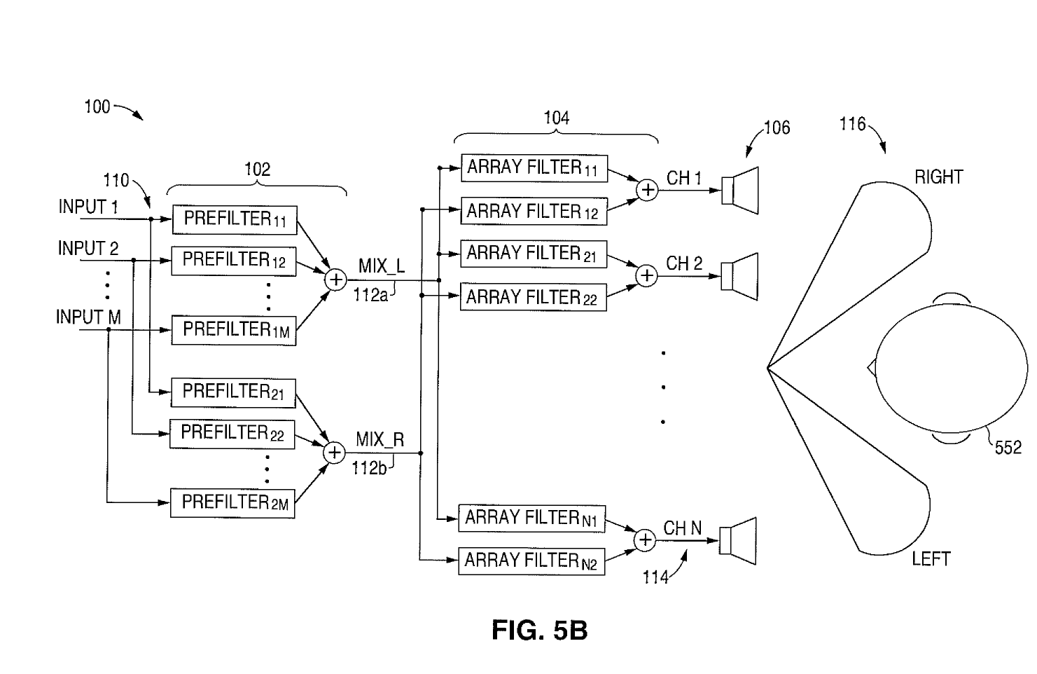

FIG. 5A illustrates the audio system 100 with the source positioner 102 of FIG. 2B and the 3D sound generator 104 of FIG. 4B in accordance with one embodiment of this disclosure. For this embodiment, a stereo input signal 110 is received at the source positioner 102 and the speaker array 106 generates a 3D sound stage 116 with adjustable source positioning for a listener 502, as described above.

FIG. 5B illustrates the audio system 100 with the source positioner 102 of FIG. 3B and the 3D sound generator 104 of FIG. 4B in accordance with one embodiment of this disclosure. For this embodiment, an M-input signal 110 is received at the source positioner 102 and the speaker array 106 generates a 3D sound stage 116 with adjustable source positioning for a listener 552, as described above.

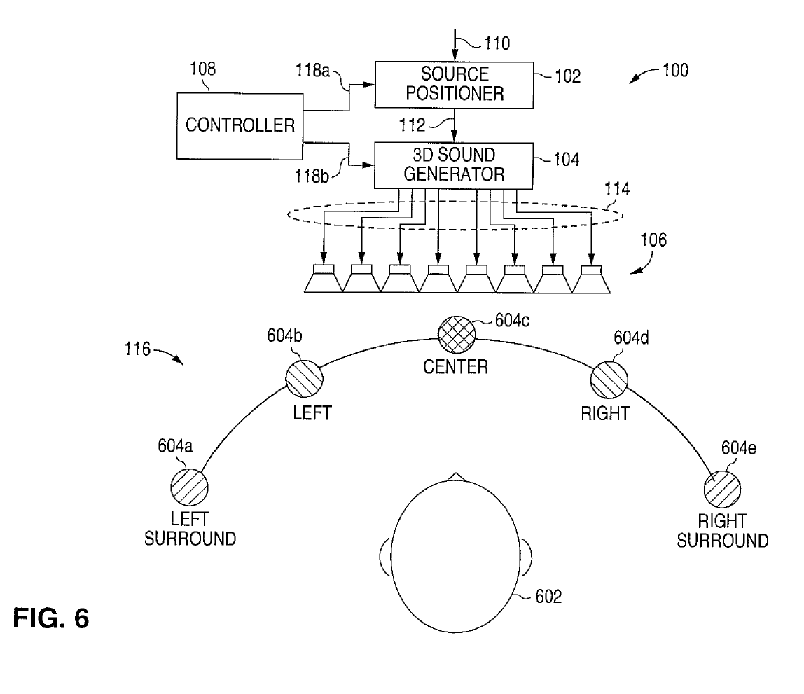

FIG. 6 illustrates one example of a 3D sound stage 116 generated by the audio system 100 in accordance with one embodiment of this disclosure. The sound stage 116 comprises a plurality of sound sources 604, each of which represents a virtual source of sound for a listener 602 generated by the audio system 100.

For this particular example, the 3D sound generator 104 generates a 3D signal 114 that results in the speaker array 106 generating a sound stage 116 comprising five sound sources 604a-e for the listener 602, as described above. Also, for this example, the speaker array 106 comprises eight speakers. However, it will be understood that the sound stage 116 generated by the audio system 100 may comprise any suitable number of sound sources 604 and the speaker array 106 may comprise any suitable number of speakers without departing from the scope of this disclosure.

The source positioner 102 is capable of modifying the audio input 110 such that the spacing between the resulting sound sources 604a and 604b, 604b and 604c, 604c and 604d, and 604d and 604e is any suitable distance. For example, for some embodiments, HRTFs are loaded into corresponding pre-filters 202 of the source positioner 102. The source positioner 102 provides a sound stage 116 in which different input channels are positioned at different angles based on those HRTFs.

For some embodiments, the source positioner 102 may be capable of adjusting the spacing uniformly for all sound sources 604. For other embodiments, the source positioner 102 may be capable of adjusting the spacing between any two sound sources 604 independently of the other sound sources 604. The 3D sound generator 104 is capable of generating the 3D signal 114 to correspond to a desired number and curvature of sound sources 604a-e.

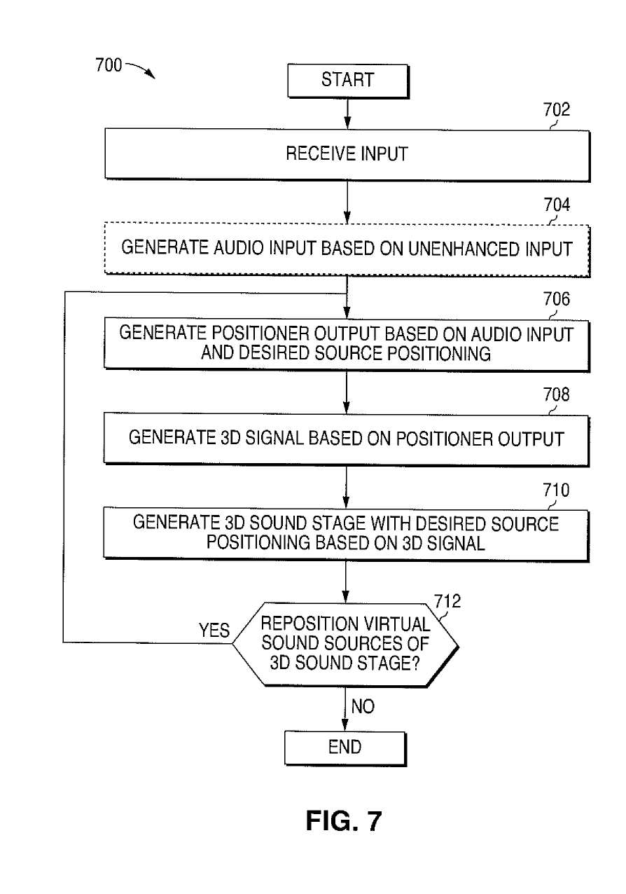

FIG. 7 illustrates a method 700 for generating 3D sound with adjustable source positioning in accordance with one embodiment of this disclosure. Initially, the audio system 100 receives an input (step 702). This input may correspond to the audio input 110, for the embodiment illustrated in FIG. 1A, or to the unenhanced input 122, for the embodiment illustrated in FIG. 1B.

For the embodiment of FIG. 1B, the sound enhancer 120 generates the audio input 110 based on the unenhanced input 122 (optional step 704). For example, the sound enhancer 120 may enhance the unenhanced input 122 by inserting any positive effects and/or reducing or eliminating any negative aspects of the unenhanced input 122. For a particular example, the sound enhancer 120 may generate the audio input 110 by providing for the Hall effect and/or reverberance. Also, the sound enhancer 120 may generate the audio input 110 based on an enhancement control signal 118c, in addition to the unenhanced input 122.

The source positioner 102 generates the positioner output 112 based on the audio input 110 and the desired source positioning as determined by a manufacturer or user of the system 100, by the controller 108 or in any other suitable manner (step 706). For example, the source positioner 102 may generate the positioner output 112 by applying one or more functions to the audio input 110, which may comprise a mono input, stereo inputs or multi-channel inputs.

The positioner output 112 may comprise a left positioner output 112a and a right positioner output 112b. For this embodiment, the source positioner 102 generates each of the positioner outputs 112a and 112b based on the entire audio input 110, whether that input 110 is a mono signal, a stereo signal or any suitable number of multi-channel signals. For a particular example, the source positioner 102 may generate each positioner output 112a and 112b by applying an HRTF to each of the audio inputs (mono, stereo or multi-channel) 110 and mixing the filtered inputs. Also, for some embodiments, the source positioner 102 may generate the positioner output 112 based on a position control signal 118a, in addition to the audio input 110.

The 3D sound generator 104 generates the 3D signal 114 based on the positioner output 112 (step 708). For example, the 3D sound generator 104 may generate the 3D signal 114 by applying one or more functions to the positioner output 112, which may comprise a left positioner output 112a and a right positioner output 112b. For some embodiments, the 3D sound generator 104 generates each of a plurality of 3D signals 114 based on both of the positioner outputs 112a and 112b. For a particular example, the 3D sound generator 104 may generate each 3D signal 114 by applying a function to each of the positioner outputs 112a and 112b and mixing the filtered outputs. Also, for some embodiments, the 3D sound generator 104 may generate the 3D signal 114 based on a 3D control signal 118b, in addition to the positioner output 112.

The speaker array 106 generates the 3D sound stage 116 with the desired source positioning based on the 3D signal 114 (step 710). For some embodiments, each speaker in the speaker array 106 receives a unique 3D signal 114 from the 3D sound generator 104 and generates a portion of the 3D sound stage 116 based on the received 3D signal 114. The sound stage 116 comprises a specified number of sound sources 604 at a specified curvature based on the action of the 3D sound generator 104 and a specified spacing between those sources 604 based on the action of the source positioner 102.

If a user or manufacturer of the system 100 or the controller 108 or other suitable entity desires to reposition the virtual sound sources 604, the method returns to step 706, where the source positioner 102 continues to generate the positioner output 112 based on the audio input 110 but also based on the modified desired source positioning (step 712).

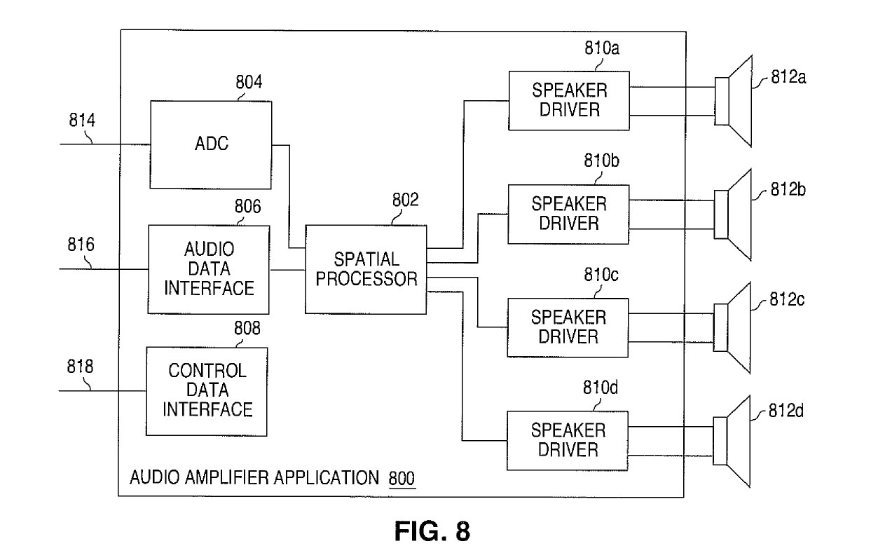

FIG. 8 illustrates one example of an audio amplifier application 800 including the audio system 100 in accordance with one embodiment of this disclosure. For the example illustrated in FIG. 8, the audio amplifier application 800 comprises a spatial processor 802, an analog-to-digital converter (ADC) 804, an audio data interface 806, a control data interface 808 and a plurality of speaker drivers 810a-d, each of which is coupled to a corresponding speaker 812a-d. It will be understood that the audio amplifier application 800 may comprise any other suitable components not illustrated in FIG. 8.

For this embodiment, the spatial processor 802 comprises the audio system 100 that is capable of generating 3D sound with adjustable source positioning. The analog-to-digital converter 804 is capable of receiving an analog audio signal 814 and converting it into a digital signal for the spatial processor 802. The audio data interface 806 is capable of receiving audio data over a bus 816 and providing that audio data to the spatial processor 802. The control data interface 808 is capable of receiving control data over a bus 818 and may be capable of providing that control data to the spatial processor 802 or other components of the audio amplifier application 800. For some embodiments, the buses 816 and/or 818 may each comprise a SLIMBUS or an I²S/I²C bus. However, it will be understood that either bus 816 or 818 may comprise any suitable type of bus without departing from the scope of this disclosure.

The spatial processor 802 is capable of generating 3D sound signals with adjustable source positioning, as described above in connection with FIGS. 1-7. The audio data provided by the analog-to-digital converter 804 and/or the audio data interface 806 may correspond to the audio input 110 of FIGURE lA or the unenhanced input 122 of FIG. 1B. The control data provided by the control data interface 808 may correspond to the control signals 118 or may be provided to an integrated controller, which may generate the control signals 118 based on the control data. Each speaker driver 810 may comprise an H-bridge or other suitable structure for driving the corresponding speaker 812. Although the illustrated embodiment includes four speaker drivers 810a-d and four corresponding speakers 812a-d, it will be understood that the audio amplifier application 800 may comprise any suitable number of speaker drivers 810. In addition, any suitable number of speakers 812 may be coupled to the audio amplifier application 800 up to the number of speaker drivers 810 included in the application 800.

For some embodiments, the control bus 818 may be capable of providing an enable signal to the audio amplifier application 800. Also, for some embodiments, a plurality of similar or identical audio amplifier applications 800 may be daisy-chained together, with each audio amplifier application 800 capable of enabling a subsequent audio amplifier application 800 through use of the enable signal over the control bus 818.

While FIGS. 1 through 8 have illustrated various features of different types of audio systems, any number of changes may be made to these drawings. For example, while certain numbers of channels may be shown in individual figures, any suitable number of channels can be used to transport any suitable type of data. Also, the components shown in the figures could be combined, omitted, or further subdivided and additional components could be added according to particular needs. In addition, features shown in one or more figures above may be used in other figures above.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases that have been used within this patent document. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The term “each” means every one of at least a subset of the identified items. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like.

While this disclosure has described certain embodiments and generally associated methods, alterations and permutations of these embodiments and methods will be apparent to those skilled in the art. Accordingly, the above description of example embodiments does not define or constrain this invention. Other changes, substitutions, and alterations are also possible without departing from the spirit and scope of this invention as defined by the following claims.

What is claimed is:

1. A system for generating 3D sound with adjustable source positioning, comprising:
a first stage configured to position a plurality of virtual sound sources through a positioner output; and
a second stage coupled to the first stage and to a speaker array comprising a plurality of speakers, wherein the second stage is configured to generate a 3D signal for the speaker array based on the positioner output, and wherein the speaker array is configured to generate a 3D sound stage comprising the virtual sound sources based on the 3D signal.

2. The system of claim 1, wherein the first stage is further configured to reposition the virtual sound sources.

3. The system of claim 1, wherein the first stage comprises:
a first source positioner configured to receive a plurality of audio inputs and generate a left positioner output based on the audio inputs; and
a second source positioner configured to receive the audio inputs and generate a right positioner output based on the audio inputs.

4. The system of claim 3, wherein:
the first source positioner comprises a first pre-filter for each of the audio inputs and a first mixer; and
the second source positioner comprises a second pre-filter for each of the audio inputs and a second mixer.

5. The system of claim 4, wherein:
for the first source positioner, each first pre-filter is configured to filter a corresponding one of the audio inputs to generate a first filtered input and the first mixer is configured to mix the first filtered inputs to generate the left positioner output; and
for the second source positioner, each second pre-filter is configured to filter a corresponding one of the audio inputs to generate a second filtered input and the second mixer is configured to mix the second filtered inputs to generate the right positioner output.

6. The system of claim 5, wherein each pre-filter is configured to filter its corresponding audio input by applying a Head-Related Transfer Function (HRTF) to its corresponding audio input.

7. The system of claim 5, wherein:
each pre-filter is configured to filter its corresponding audio input by applying a first function to its corresponding audio input; and
the pre-filters are further configured to reposition the virtual sound sources by, for at least one of the pre-filters, applying a second function to its corresponding audio input, wherein the second function is different from the first function.

8. The system of claim 3, wherein the second stage comprises a plurality of 3D sound generators, and wherein each of the 3D sound generators comprises a first array filter, a second array filter and a mixer.

9. The system of claim 8, wherein, for each 3D sound generator:
the first array filter is configured to filter the left positioner output to generate a filtered, left positioner output;
the second array filter is configured to filter the right positioner output to generate a filtered, right positioner output;
and
the mixer is configured to mix the filtered outputs to generate a 3D signal for a corresponding one of the speakers coupled to the 3D sound generator.

10. The system of claim 1, further comprising:
a third stage coupled to the first stage, the third stage comprising a sound enhancer configured to enhance an unenhanced input to generate an audio input for the first stage, wherein the first stage is audio input position the virtual sound sources based on the audio input.

11. A method for generating 3D sound with adjustable source positioning, comprising:
generating a positioner output based on an audio input;
generating a 3D signal based on the positioner output; and
generating a 3D sound stage based on the 3D signal, wherein the 3D sound stage comprises a plurality of virtual sound sources spaced at specified distances from each other, and wherein the specified distances are based on the positioner output.

12. The method of claim 11, wherein generating the positioner output comprises applying a plurality of pre-filters to the audio input.

13. The method of claim 12, further comprising:
loading each pre-filter with a corresponding first function, wherein applying the pre-filters to the audio input comprises applying the loaded first function for each pre-filter to the audio input; and
modifying the specified distances between the virtual sound sources by loading at least one of the pre-filters with a second function different from the first function.

14. The method of claim 12, wherein:
the audio input comprises a plurality of audio inputs; and
generating the positioner output comprises:
filtering each of the audio inputs with a first set of pre-filters to generate a first set of filtered inputs and mixing the first set of filtered inputs to generate a left positioner output; and
filtering each of the audio inputs with a second set of pre-filters to generate a second set of filtered inputs and mixing the second set of filtered inputs to generate a right positioner output.

15. The method of claim 14, wherein:
the 3D signal comprises a plurality of 3D signals; and
generating the 3D signal comprises:
filtering the left positioner output with a first set of array filters to generate a first set of filtered outputs;
filtering the right positioner output with a second set of array filters to generate a second set of filtered outputs; and
mixing each one of the first set of filtered outputs with a corresponding one of the second set of filtered outputs to generate a 3D signal for each of a plurality of speakers.

16. The method of claim 11, further comprising enhancing an unenhanced input to generate the audio input.

17. An audio amplifier application, comprising:
an audio data interface configured to provide audio data;
a spatial processor coupled to the audio data interface and configured to receive the audio data, the spatial processor comprising (i) a first stage configured to position a plurality of virtual sound sources based on the audio data by generating a positioner output and (ii) a second stage coupled to the first stage and configured to generate a 3D signal based on the positioner output, the first stage further configured to reposition the virtual sound sources by generating a subsequent positioner output; and
a plurality of speaker drivers coupled to the spatial processor, wherein each speaker driver is configured to drive a corresponding one of a plurality of speakers based on the 3D signal to generate a 3D sound stage comprising the virtual sound sources.

18. The audio amplifier application of claim 17, further comprising a control data interface configured to provide control signals to the spatial processor, wherein the first stage is configured to position and reposition the virtual sound sources based on the control signals.

19. The audio amplifier application of claim 18, wherein the first stage comprises a plurality of pre-filters, wherein the control signals are configured to load a corresponding function into each of the pre-filters, and wherein the first stage is configured to position the virtual sound sources by applying the loaded functions in the pre-filters to the audio data.

20. The audio amplifier application of claim 18, wherein the control data interface is configured to receive an enable signal from an adjacent audio amplifier application, and wherein the enable signal is configured to enable the operation of the audio amplifier application.
